(19) United States
(12) Patent Application Publication
(10) Pub. No.: US 2002/0118052 A1
(43) Pub. Date: Aug. 29, 2002

(54) Differential charge pump circuit

(76) Inventor: Hsueh-Wu Kao, Hsin Chu County (TW)

Correspondence Address: BIRCH STEWART KOLASCH & BIRCH, PO BOX 747, FALLS CHURCH, VA, 22040-0747, US

(21) Appl. No.: 10/041,490

(22) Filed: Jan. 10, 2002

(30) Foreign Application Priority Data
Jan. 11, 2001 (TW) 090100669

(51) Int. Cl. G05F 3/02

(52) U.S. Cl. 327/157; 327/536

(57) ABSTRACT

A differential charge pump circuit for eliminating influence of mismatches between current sources and keeping an output signal with 50% duty cycle is disclosed. The differential charge pump circuit includes a capacitor providing an output voltage, a slicer for outputting a comparison signal to control a charge/discharge actions of the capacitor, a first current source, a second current source, a first-common-mode current source, a second-common-mode current source, and a third-common-mode current source connected in parallel with the first current source. The differential charge pump circuit of the present invention utilizes switches to switch the charge and discharge current paths of the capacitor with respect to the common mode current source and the charge/discharge current source. Therefore, the duty cycle of the output signal is free from being adversely influenced by the mismatches between the current sources.

### BACKGROUND OF THE INVENTION

A. Field of the Invention

The invention relates to a differential charge pump circuit, and more particularly, to a differential charge pump circuit using a method of exchanging common mode current sources to decrease the influence of the mismatches between the common mode currents upon the duty cycle.

B. Description of the Related Art

A general charge pump circuit is a close-loop control system that has to output a signal having a duty cycle of 50%. FIG. 1 shows a single-end charge pump used in a single-end close loop system having a duty cycle of 50%, wherein the output signal of the slicer is one having a 50% duty cycle of the charge pump circuit. When the close loop feedback system reaches its equilibrium state, the charging charge is equal to the discharging charge in the same one cycle. That is,

Iᵤₚ*X%=I_{dn}*(100−X%),

wherein X is the duty cycle, Iᵤₚ is the current of the upper charging current source, and I_{dn} is the current of the lower discharging current source. Thus, the duty cycle of the system is:

X=(Iᵤₚ/(Iᵤₚ+I_{dn})) (1)

However, the signal with accurate 50% duty cycle can not be generated owing to the following reasons: i) there are some mismatches between the currents Iᵤₚ and I_{dn} in the semiconductor manufacturing processes; and 2) the noises of the common mode reference voltage Vref.

Consequently, a differential charge pump circuit as shown in FIG. 2 has been disclosed to solve the problem of current mismatches between the currents Iᵤₚ and I_{dn}. In this charge pump circuit, the charging and discharging actions are performed at both terminals of the capacitor C. In addition, the two terminals of the capacitor C are switched according to the output result (H or L) in order to compensate the problem of current mismatches between the upper charging and lower discharging current sources.

FIG. 3 shows the charge and discharge paths for the differential charge pump circuit in FIG. 2, wherein φH indicates that the controlled switch is ON when the slicer is H, while φL indicates that the controlled switch is ON when the slicer is L.

Once the differential charge pump circuit is adopted, it is necessary to provide a common mode path between the two terminals of the capacitor C in order to set the common mode voltage at the two terminals of the capacitor C.

The right-hand common mode current I_{CMR} and the left-hand common mode current I_{CML} provide a common mode path. FIGS. 4(A) and 4(B) show the operation modes when the output of the slicer is H and L, respectively. However, there will be some mismatches between I_{CMR} and I_{CML} in the semiconductor manufacturing processes. As shown in FIG. 4, it is assumed that the right-hand common mode current I_{CMR} equals to K times of the left-hand common mode current I_{CML}, and that I_{CM1} and I_{CM0} equal to the left-hand common mode currents I_{CML} when the output of the slicer is H and L, respectively. Under this condition and assumption, the current flowing into the upper plate of the capacitor C equals to the current flowing out of the bottom plate of the capacitor. Therefore,

I₁=Iᵤₚ+I_{CM}−I_{CM1}=I_{dn}+KI_{CM1} (2)

I₀=Iᵤₚ+I_{CM}−KI_{CM0}=I_{dn}+I_{CM0} (3).

From the equations (2) and (3), I_{CM1}=I_{CMO}

I₁*X=I₀*(1−X) (4)

(Iᵤₚ+I_{CM}−I_{CM1})*X=(I_{dn}+I_{CM0})*(1−X)X=(Iᵤₚ+I_{CM}−KI_{CM1})/(2Iᵤₚ+2I_{CM}−(1+K)I_{CM1}) (5).

If K=1, the left-hand and right-hand common mode currents fully match with each other, and

X=50% (6)

Accordingly, it can be proved from Equation (6) that the duty cycle X is independent of the current Iᵤₚ and I_{dn} when K=1. However, under the condition that K≠1 (i.e., the left-hand common mode current I_{CML} is not equal to the right-hand common mode current I_{CMR}, the duty cycle X still cannot be kept at 50%.

### SUMMARY OF THE INVENTION

In view of the above-mentioned problems, it is therefore an object of the invention to provide a differential charge pump circuit without the influence of the mismatches between the common mode current and the charge/discharge current, and capable of keeping a 50% duty cycle.

One aspect of the present invention is to provide a differential charge pump circuit for eliminating influence of mismatches between current sources and keeping an output voltage having a 50% duty cycle. The differential charge pump circuit includes a capacitor, a slicer, a first current source, a second current source, a first-common-mode current source, a second-common-mode current source, and a third-common-mode current source. The capacitor has a first terminal and a second terminal and provides an output voltage. The slicer outputs a comparison signal to control a charge/discharge action of the capacitor. The first current source includes a positive terminal and a negative terminal. The positive terminal is connected to a positive reference voltage. The negative terminal is connected to the first terminal of the capacitor when the comparison signal is H, and to the second terminal of the capacitor when the comparison signal is L. The second current source includes a positive terminal and a negative terminal. The negative terminal of the second current source is connected to a negative reference voltage. The positive terminal of the second current source is connected to the second terminal of the capacitor when the comparison signal is H, and to the first terminal of the capacitor when the comparison signal is L. The first-common-mode current source includes a positive terminal and a negative terminal. The negative terminal is connected to the negative reference voltage. The positive terminal is connected to the first terminal of the capacitor when the comparison signal is H, and to the second terminal of the capacitor when the comparison signal is L. The second-common-mode current source includes a positive terminal and a negative terminal. The negative terminal is connected to the negative reference voltage. The positive terminal is connected to the second terminal of the capacitor when the comparison signal is H, and to the first terminal of the capacitor when the comparison signal is L. The third-common-mode current source is connected in parallel with the first current source.

### BRIEF DESCRIPTION OF THE DRAWINGS

These and other objects and advantages of the present invention will become apparent by reference to the following description and accompanying drawings wherein:

FIG. 1 shows a conventional single-end charge pump;

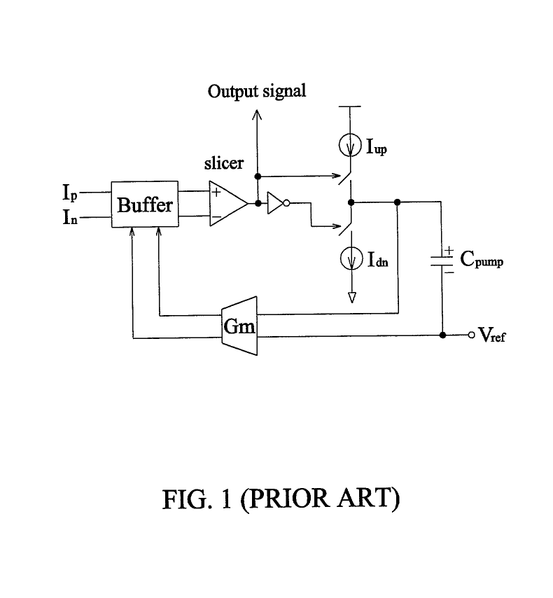

FIG. 2 shows a conventional differential charge pump;

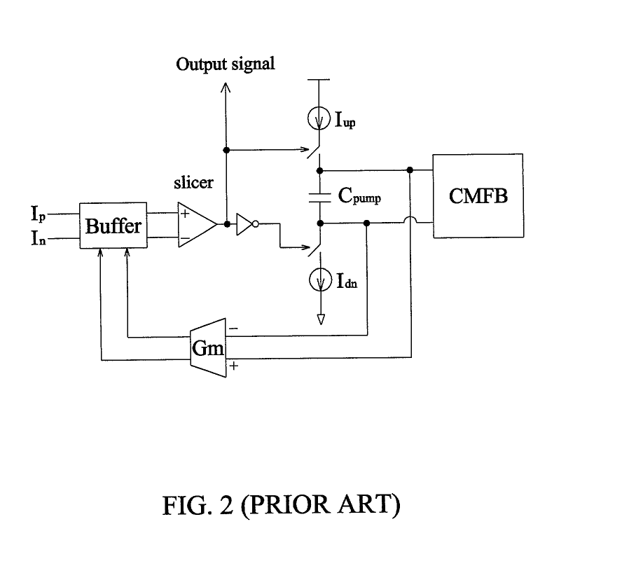

FIG. 3 shows the circuit of the differential charge pump of FIG. 2;

FIG. 4 shows the charge paths of FIG. 3, wherein FIG. 4(A) shows the charge path when the slicer is H, and FIG. 4(B) shows the charge path when the slicer is L;

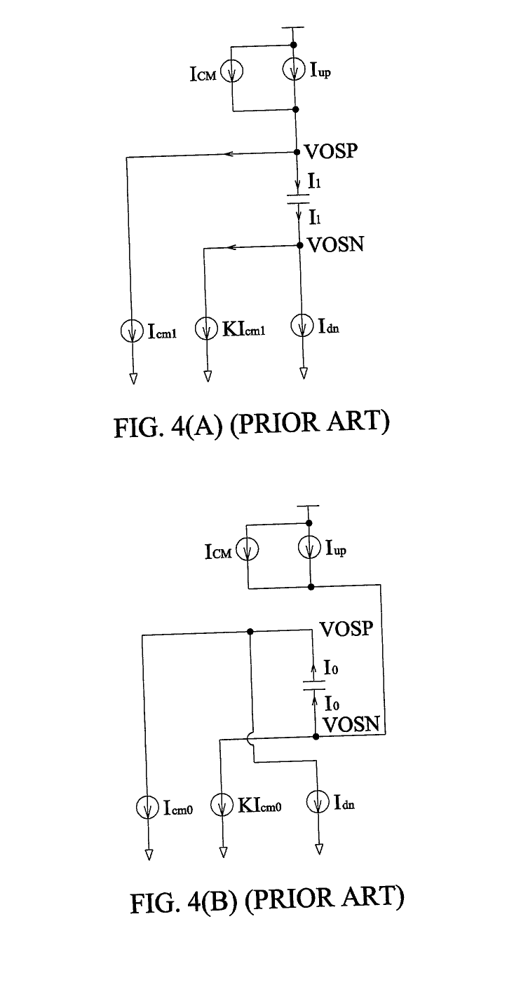

FIG. 5 shows the circuit of the differential charge pump in accordance with the first embodiment of the present invention;

FIG. 6 shows the charge path of FIG. 5, wherein FIG. 6(A) shows the charge path when the slicer is H, and FIG. 6(B) shows the charge path when the slicer is L;

FIG. 7 shows a simplified circuit of the differential charge pump of the FIG. 5; and

FIG. 8 shows a simplified circuit of the differential charge pump of the FIG. 7.

### DETAIL DESCRIPTION OF THE INVENTION

The differential charge pump circuit of the present invention will be described with reference to the accompanying drawings.

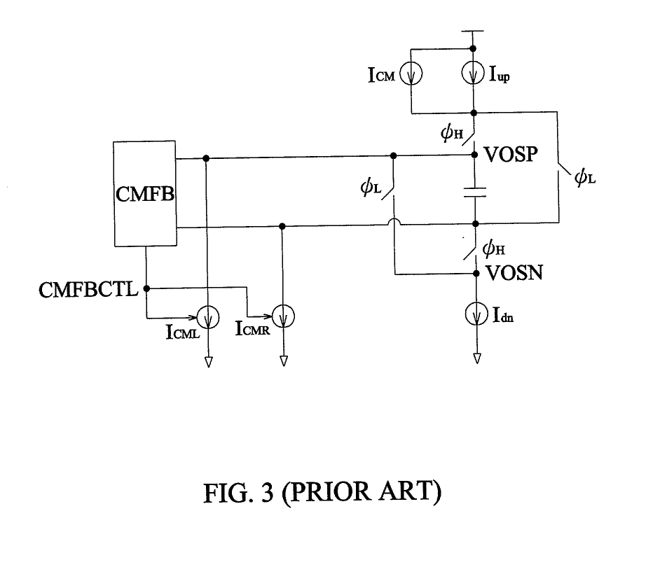

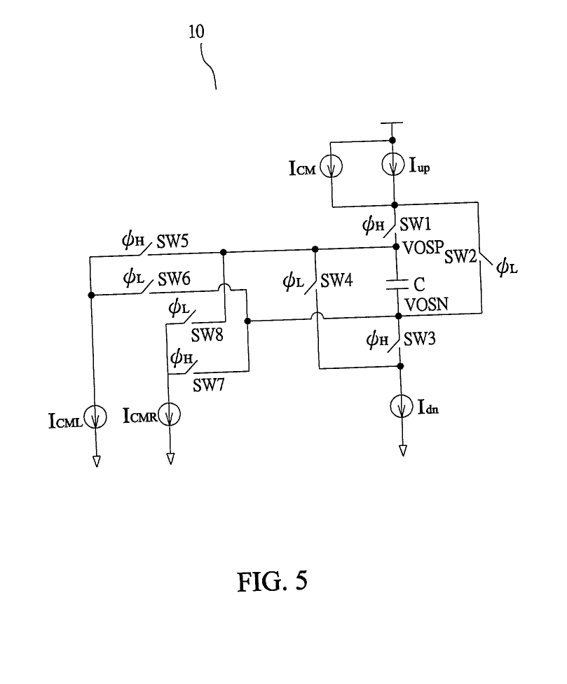

FIG. 5 shows the differential charge pump circuit in accordance with a first embodiment of the present invention. As shown in this drawing, the differential charge pump 10 is the same as a general differential charge pump (as shown in FIG. 3) in that slicers are used to switch the charge and discharge paths of each current source with respect to the capacitor C. The conventional differential charge pump only switches the charge and discharge paths of the upper charging current source Iᵤₚ and the lower discharging current source I_{dn} with respect to the capacitor C. The differential charge pump 10 of this present invention, however, switches not only the charge and discharge paths of the upper charging current source Iᵤₚ and the lower discharging current source I_{dn} with respect to the capacitor C, but also the charge and discharge paths of the common mode current source with respect to the capacitor C. Therefore, the differential charge pump 10 of this present invention is free from being influenced by the mismatches between the upper charging current source, the lower discharging current source, and the common mode current source, and still can keep the output with 50% duty cycle.

As shown in FIG. 5, the differential charge pump 10 of the present invention includes a capacitor C, an upper charging current source Iᵤₚ, a lower discharging current source, a common mode current source I_{CM}, a left-hand common mode current source I_{CML}, and a right-hand common mode current source I_{CMR}.

A positive terminal VOSP and a negative terminal VOSN of the capacitor C provide output voltages. The common mode current source I_{CM} and the upper charging current source Iᵤₚ are connected in parallel, connected to the positive terminal VOSP of the capacitor C via a first switch SW1, and connected to the negative terminal VOSN of the capacitor C via the second switch SW2. The lower discharging current source I_{dn} is connected to the negative terminal VOSN of the capacitor C via a third switch SW3, and is connected to the positive terminal VOSP of the capacitor C via a fourth switch SW4. The left-hand common mode current source I_{CML} is connected to the positive terminal VOSP of the capacitor C via a fifth switch SW5, and is connected to the negative terminal VOSN of the capacitor C via a sixth switch SW6. The right-hand common mode current source I_{CMR} is connected to the negative terminal VOSN of the capacitor C via a seventh switch SW7, and is connected to the positive terminal VOSP of the capacitor C via an eighth switch SW8.

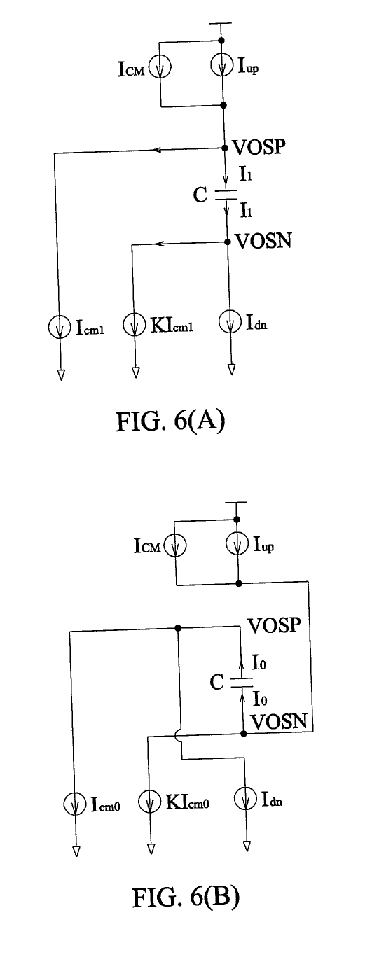

FIGS. 6(A) and 6(B) show current paths when the output of the slicer of FIG. 5 is H and L, respectively. The fact that the differential charge pump of this present invention is free from being influenced by the mismatches between the common mode current and the charge and discharge currents and the fact that the charge pump can keep a 50% duty cycle output will be proved in the following. First, it is assumed that the right-hand common mode current I_{CMR} equals to K times of the left-hand common mode current I_{CML}, that I_{CM1} equals to the left-hand common mode currents I_{CML} when the slicer is H, and that I_{CM0} equals to the left-hand common mode currents I_{CML} when the slicer is L. Under this assumption with reference to FIGS. 6(A) and 6(B), we obtain

I₁=Iᵤₚ+I_{CM}−I_{CM1}=I_{dn}+KI_{CM1} (7)

I₀=Iᵤₚ+I_{CM}−I_{CM0}=I_{dn}+KI_{CM0} (8).

From Equation (8), we can obtain:

I_{dn}=Iᵤₚ+I_{CM}−(K+1)I_{CM0} (9)

I_{CM0}=I_{CM1} (10)

I₁*X=I₀*(1−X) (11).

Substitute Equations (7) and (8) into Equation (11), we obtain:

(Iᵤₚ+I_{CM}−I_{CM1})*X=(I_{dn}+KI_{CM0})*(1−X) (12)

X=(I_{dn}+KI_{CM0})/(Iᵤₚ+I_{CM}−I_{CM1}+I_{dn}+KI_{CM0}) (13).

Substitute Equations (9) and (10) into Equation (13), we obtain:

X=(Iᵤₚ+I_{CM}−I_{CM1})/(2Iᵤₚ+2I_{CM}−2I_{CM1})=50% (14)

As a result, it can be proved from Equation (14) that the duty cycle X is a constant (50%), and is independent of the matches/mismatches between the upper charging current source, the lower discharging current source, and the common mode current.

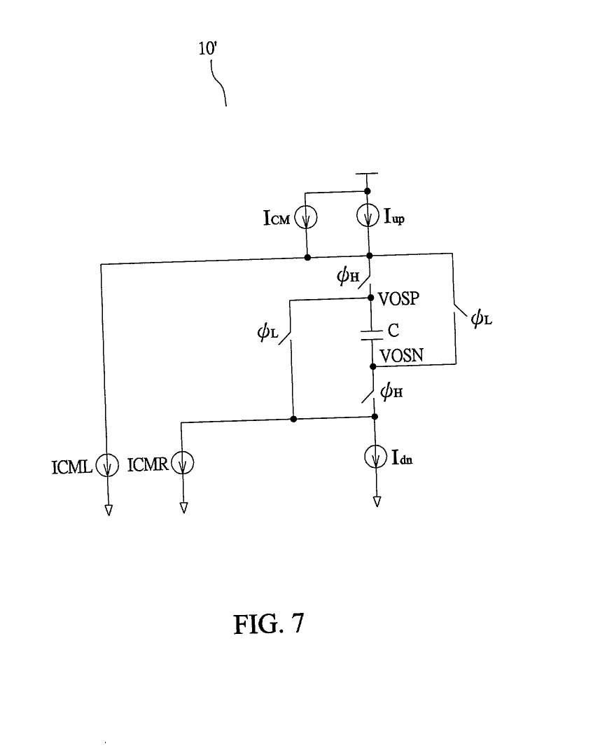

FIG. 7 shows a simplified circuit of the charge pump 10 of FIG. 5. The left-hand common mode current source I_{CML} of the charge pump 10 in FIG. 5 is connected to the upper charging current source Iᵤₚ when either the fifth switch SW5 or the sixth switch SW6 is ON. Therefore, the left-hand common mode current source I_{CML} can be directly connected to the upper charging current source Iᵤₚ without the fifth switch SW5 and the sixth switch SW6. Similarly, the right-hand common mode current source I_{CMR} of the charge pump 10 of FIG. 5 is always connected to the lower discharging current source I_{dn} when either the seventh switch SW7 or the eighth switch SW8 is ON. Therefore, the right-hand common mode current source can be directly connected to the lower discharging current source I_{dn} without the seventh switch SW7 and the eighth switch SW8. Consequently, the charge pump 10′ of FIG. 7 is a simplified circuit of the charge pump 10 of FIG. 5, and both the charge pumps 10′ and 10 have the same effect.

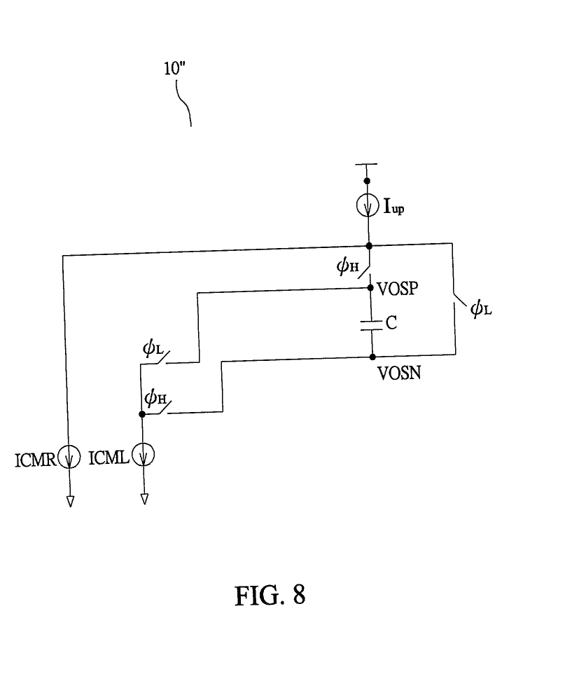

FIG. 8 shows a simplified circuit of the charge pump 10′ of the FIG. 7. In the charge pump 10′ of FIG. 7, since the common mode current source I_{CM} and the upper charging current source Iᵤₚ are connected in parallel, the common mode current source I_{CM} can be incorporated into the upper charging current source Iᵤₚ. Similarly, since the right-hand common mode current source I_{CMR} and the lower discharging current source I_{dn} are connected in parallel, the lower discharging current source I_{dn} can be incorporated into the right-hand common mode current source I_{CMR}. As a result, the differential charge pump of the present invention as shown in FIG. 8 only needs three current sources, and the duty cycle can be free from being adversely influenced by the mismatches between the current sources.

The charge pump of the present invention utilizes switches to switch the charge and discharge current paths of the capacitor with respect to the common mode current source and the charge/discharge current source. Therefore, the duty cycle of the output signal is free from being adversely influenced by the mismatches between the current sources. In addition, since some switches can be omitted, the circuit can be further simplified.

Furthermore, since the charge pump of this invention possesses good immunity from mismatches between current sources, it is not necessary to use long channel devices or large area devices to assure better processing matches during the circuit layout. Therefore, the chip size can be greatly reduced, thereby decreasing the cost.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A differential charge pump circuit for eliminating influence of mismatches between current sources, the differential charge pump circuit comprising:
a capacitor for providing the output voltage and having a first terminal and a second terminal;
a slicer for outputting a comparison signal to control charge/discharge actions of said capacitor;
a first current source having a positive terminal and a negative terminal, the positive terminal being connected to a positive reference voltage, the negative terminal being connected to the first terminal of said capacitor when said comparison signal is a first level, and the negative terminal being connected to the second terminal of said capacitor when said comparison signal is a second level;
a second current source having a positive terminal and a negative terminal, the negative terminal being connected to a negative reference voltage, the positive terminal being connected to the second terminal of said capacitor when said comparison signal is the first level, and the positive terminal being connected to the first terminal of said capacitor when said comparison signal is the second level;
a first-common-mode current source having a positive terminal and a negative terminal, the negative terminal being connected to the negative reference voltage, the positive terminal being connected to the first terminal of said capacitor when said comparison signal is the first level, and the positive terminal being connected to the second terminal of said capacitor when said comparison signal is the second level;
a second-common-mode current source having a positive terminal and a negative terminal, the negative terminal being connected to the negative reference voltage, the positive terminal being connected to the second terminal of said capacitor when said comparison signal is the first level, and the positive terminal being connected to the first terminal of said capacitor when said comparison signal is the second level; and
a third-common-mode current source connected in parallel with the first current source.

2. The differential charge pump circuit according to claim 1, wherein said third-common-mode current source and said first current source are combined into a single current source.

3. The differential charge pump circuit according to claim 1, wherein said first level is a high level and said second level is a low level.

4. A differential charge pump circuit for eliminating influence of mismatches between current sources, the differential charge pump circuit comprising:
a capacitor for providing an output voltage and having a first terminal and a second terminal;
a slicer for outputting a comparison signal to control charge/discharge actions of said capacitor;
a first current source having a positive terminal and a negative terminal, the positive terminal being connected to a positive reference voltage;
a first switch connected between the negative terminal of said first current source and the first terminal of said capacitor, said first switch being turned ON when said comparison signal is a first level;
a second current source having a positive terminal and a negative terminal, the negative terminal being connected to a negative reference voltage;
a second switch connected between the second terminal of said capacitor and the positive terminal of said second current source, said second switch being turned ON when said comparison signal is the first level;
a third switch connected between the negative terminal of said first current source and the second terminal of said capacitor, said third switch being turned ON when said comparison signal is a second level;
a fourth switch connected between the first terminal of said capacitor and the positive terminal of said second current source, said fourth switch being turned ON when said comparison signal is the second level;
a first-common-mode current source having a positive terminal and a negative terminal, the negative terminal being connected to the negative reference voltage, and the positive terminal being connected to the negative terminal of said first current source;
a second-common-mode current source having a positive terminal and a negative terminal, the negative terminal being connected to the negative reference voltage, and the positive terminal being connected to the positive terminal of said second current source; and
a third-common-mode current source connected in parallel with said first current source.

5. The differential charge pump circuit according to claim 4, wherein the first level is a high level and the second level is a low level.

6. The differential charge pump circuit according to claim 4, wherein said third-common-mode current source and said first current source are combined into a single current source.

7. The differential charge pump circuit according to claim 4, wherein said second current source and said second-common-mode current source are combined into a single current source.

8. A differential charge pump circuit for eliminating influence of mismatches between current sources, the differential charge pump circuit comprising: a capacitor for providing an output voltage and having a first terminal and a second terminal;
a slicer for outputting a comparison signal to control charge/discharge actions of said capacitor;
a first current source having a positive terminal and a negative terminal, the positive terminal being connected to a positive reference voltage;
a first switch connected between the negative terminal of said first current source and the first terminal of said capacitor, said first switch being turned ON when said comparison signal is a first level;
a second current source having a positive terminal and a negative terminal, the negative terminal being connected to a negative reference voltage;
a second switch connected between the second terminal of said capacitor and the positive terminal of said second current source, said second switch being turned ON when said comparison signal is the first level;
a third switch connected between the negative terminal of said first current source and the second terminal of said capacitor, said third switch being turned ON when said comparison signal is a second level;
a fourth switch connected between the first terminal of said capacitor and the positive terminal of said second current source, said fourth switch being turned ON when said comparison signal is the second level; and
a common mode current source having a positive terminal and a negative terminal, the negative terminal being connected to the negative reference voltage, and the positive terminal being connected to the negative terminal of said first current source.

9. The differential charge pump circuit according to claim 8, wherein the first level is a high level and the second level is a low level.
